(19) United States
(12) Patent Application Publication
(10) Pub. No.: US 2026/0074357 A1
(43) Pub. Date: Mar. 12, 2026

(54) CELL HOUSING ARRANGEMENT WITH A CELL HOUSING AND A HEAT PROTECTION ELEMENT FOR STABILIZING THE CELL HOUSING, BATTERY CELL AND MOTOR VEHICLE

(71) Applicant: AUDI AG, lngolstadt (DE)

(72) Inventor: Sabrina DONNERBAUER, München (DE)

(73) Assignee: AUDI AG, lngolstadt (DE)

(21) Appl. No.: 19/306,008

(22) Filed: Aug. 21, 2025

(30) Foreign Application Priority Data
Sep. 12, 2024 (DE) 102024126305.9

(51) Int. Cl. H01M 50/342; H01M 50/103; H01M 50/133; H01M 50/143

(52) U.S. Cl. CPC H01M 50/3425; H01M 50/103; H01M 50/133; H01M 50/143; H01M 2220/20

(57) ABSTRACT

A cell housing arrangement with a cell housing for a prismatic battery cell, the cell housing has a first cell wall in which a releasable cell degassing opening is arranged, a second and third cell wall which are opposite one another and each adjoin the first cell wall via a first and second edge of the cell housing, and the cell housing arrangement has at least one heat protection element which is arranged at least externally on at least part of the second cell wall. In particular, the heat protection element is designed as a metal foil or as a fire protection paper.

### FIELD

The invention relates to a cell housing arrangement with a cell housing for a prismatic battery cell, wherein the cell housing has a first cell wall in which a releasable cell degassing opening is arranged, a second and third cell wall which are opposite one another and each adjoin the first cell wall via a first and second edge of the cell housing, and wherein the cell housing arrangement has at least one heat protection element which is arranged at least externally on at least part of the second cell wall. Furthermore, the invention also relates to a battery cell and a motor vehicle.

### BACKGROUND

Battery cells or their cell housing often have a releasable cell degassing opening, for example in the form of a bursting membrane, through which such a battery cell can outgas in a controlled manner in the event of thermal runaway, in order to prevent a bursting of the battery cell. However, if the cell integrity is poor, thermal runaway may cause the cell housing to rupture in places where it should not. This leads to unwanted gas flows along unintended paths. In a cell network, the hot gas escaping at undesirable locations also increases the probability of inflammation of neighboring cells.

DE 10 2021 000 029 A1 describes a multi-layer protective element of a battery with a heat-resistant carrier layer and a fiber layer, wherein the protective element has gas permeability. It can be provided that battery cells of a battery are individually encased by such a protective element.

The use of multi-layer protective elements in a battery usually requires a lot of installation space. In addition, a gas-permeable design of such a protective element often reduces its protective function, since hot gases, for example, can then penetrate such a protective element more easily.

EP 4 199 222 A1 describes a battery cell with a cell housing and a safety valve, as well as with a fabric band that surrounds the housing and covers the safety valve so that gas can pass through the fabric band.

DE 10 2021 130 417 A1 describes an energy storage cell with a cylindrical housing that forms the cell housing and is partially made of steel and/or aluminum and is therefore electrically conductive. To provide electrical insulation of the battery cells, an additional coating is provided on the housing, which is electrically insulating and can be implemented as a cathodic dip coating (CDC) and/or anodization.

### SUMMARY

The object of the present invention is to provide a cell housing arrangement, a battery cell and a motor vehicle which, in the event of a thermal runaway of a battery cell, make it possible to reduce as much as possible the probability of gas escaping at undesirable locations in the cell housing.

A cell housing arrangement according to the invention comprises a cell housing for a prismatic battery cell, wherein the cell housing has a first cell wall in which a releasable cell degassing opening is arranged, a second and third cell wall which are opposite one another and each adjoin the first cell wall via a first and second edge of the cell housing, and wherein the cell housing arrangement has at least one heat protection element which is arranged at least externally on at least part of the second cell wall. The heat protection element is designed as a metal foil or as a fire protection paper.

Both metal foils and fire protection papers typically have very high heat resistance and mechanical strength, which in turn allows the heat protection element to be particularly thin and, in particular, single-layered. This in turn enables savings in installation space, costs and weight, but above all it makes it particularly easy to attach the heat protection element to the cell housing in a tolerance-compensating and form-fitting manner. This significantly increases the heat protection element's stabilizing effect on the cell housing. In this case, the arrangement of such a heat protection element in the form of a metal foil or a fire protection paper on a side wall of the cell housing, in particular a side wall of the prismatic cell housing with the largest area, for example the second or third cell wall, is particularly advantageous, since this allows the cell housing to be supported laterally and/or mechanically stabilized and a defined outgassing of the cell via the cell degassing opening in the first cell wall can be promoted. In particular, outgassing from the battery cell to neighboring cells via undesirable paths, for example via the side walls, can thus be efficiently prevented.

A prismatic battery cell is essentially cuboid-shaped. The same applies to the cell housing of such a battery cell. The cell housing typically encloses a cell interior, i.e. has an interior space in which a cell chemical system can be arranged, thereby providing a battery cell. Such a prismatic cell housing thus has six cell walls that lie opposite each other in pairs. The first and second cell walls are preferably the largest cell walls in terms of surface area of the cell housing. In a cell stack with a plurality of battery cells arranged next to one another in a stacking direction, the battery cells are preferably arranged in such a way that their cell walls with the largest surface area face one another. By arranging the heat protection element at least on a part of such a cell wall with the largest area, in this case the second cell wall, protection can be provided above all for neighboring cells in a cell stack.

A releasable cell degassing opening refers to an opening that is closed and can be released, i.e. opened, under certain circumstances. Such a releasable cell degassing opening can therefore have a closed state and an open state and can transition from the closed state to the open state. This transition does not have to be reversible. It may be that a transition from the open state to the closed state is no longer possible, e.g. in the case of a cell degassing opening designed as a bursting membrane. The releasable cell degassing opening can be designed as a passively pressure-dependent releasable cell degassing opening, for example as a pressure relief valve and/or bursting membranes and/or predetermined breaking points in the cell housing, or similar. The releasable degassing opening is therefore normally closed and thus separates the interior of the battery cell from the environment in a fluid-tight manner. Above a certain overpressure, the cell degassing opening opens and thus creates a fluidic connection between the interior of the battery cell and its surroundings in order to allow gas to escape from the battery cell.

The cell housing can be made of aluminum, for example. Other materials are also possible. Aluminum has the advantage that it allows for particularly weight-saving and inexpensive cell housings. In combination with the heat protection element, sufficient stability can still be ensured in the event of a thermal runaway of a battery cell. The heat protection element does not necessarily have to cover the entire second cell wall, although this is still possible. The heat protection element can also be provided only in a partial region of the second cell wall.

A metal foil is a thin, flat element made of a metallic material. Such a thin, flat element can also be understood as fire protection paper. A fire protection paper can be provided as a fiber product and is in particular made of a non-metallic and/or electrically insulating material. Such a fire protection paper can in particular be provided as a non-woven and/or non-textile flat element. Fire protection papers typically have very high temperature resistance and are flame-retardant. Both the metal foil and the fire protection paper can be flexible and/or bendable and/or foldable. This allows them to fit snugly against the cell housing in the form of the heat protection element. The heat protection element can also be called a protective skin.

In an advantageous embodiment of the invention, the heat protection element is arranged on at least a part of the first cell wall and at least partially or completely covering at least the first edge with respect to an edge longitudinal direction. The edge longitudinal direction can be defined as a first direction, for example. If the cell housing is arranged as part of a battery cell in a cell stack, this is preferably directed perpendicular to such a stacking direction. The heat protection element can therefore be angled or folded. This therefore comprises at least a first element region which lies against the second cell wall and a second element region which lies against the first cell wall, so that at least the first edge is covered by the heat protection element. This is based on the finding that in the event of thermal runaway of a battery cell and in the event of outgassing of such a battery cell, the cell housings will tear open, especially in the region of the edges adjacent to the cell wall where the releasable cell degassing opening is provided. Because the heat protection element covers at least the first edge, destruction of the cell housing or unintentional tearing of the cell housing can be advantageously prevented, especially in the region of this edge. In relation to the longitudinal edge direction, the heat protection element can cover the first edge completely or only partially. With respect to the first direction, the releasable cell degassing opening can be arranged, for example, centrally or in a central region of the first cell wall. In this case, it is advantageous if the heat protection element, with respect to the first direction corresponding to the longitudinal direction of the edge, also covers at least that region of the edge which is arranged centrally or in a central region. Particularly efficient protection is provided when the heat protection element completely covers the first edge in the longitudinal direction of the edge.

In an advantageous embodiment of the invention, the heat protection element is also arranged on at least a part of the third cell wall while at least partially or completely covering the second edge with respect to an edge longitudinal direction. In a corresponding manner, appropriate protection can also be provided for the third cell wall and, above all, the second edge. The heat protection element is preferably designed in one piece. Therefore, there is no need to provide several individual heat protection elements to cover the two edges. The heat protection element can, for example, be U-shaped, e.g. folded, when viewed in cross-section perpendicular to the longitudinal edge direction. For example, in addition to the two first and second element regions already described above, the heat protection element may also have a third element region which is adjacent to the third cell wall on the outside. The individual element regions can be adjacent to one another and, for example, be essentially rectangular.

Here, too, the heat protection element can cover the second edge completely or only partially, for example only in a central region relative to the longitudinal direction of the edge.

According to a further advantageous embodiment of the invention, the heat protection element extends on the first cell wall, in particular flatly, from the first to the second edge and has a recess in the region of the releasable cell degassing opening. The recess can be in the form of a through opening or a hole or something similar. The geometry of the recess can correspond to the geometry of the releasable cell degassing opening. Preferably, the recess is such that the releasable cell degassing opening is not covered by the heat protection element. The edge of such a recess can, for example, directly border the circumferential boundary of such a releasable cell degassing opening. This means that the gas is not prevented from escaping from the battery cell, in particular from the releasable cell degassing opening, without the heat protection element itself having to be made gas-permeable. The metal foil or fire protection paper can therefore be essentially gas-impermeable.

According to a further advantageous embodiment of the invention, the heat protection element is flexible and in particular has a material thickness of a maximum of one millimeter. In other words, the flexibility of the heat protection element can be achieved through a particularly thin material thickness, for example of a maximum of one millimeter or even less. This allows the heat protection element to fit particularly easily and securely against the surface of the cell housing. Gaps can be prevented particularly efficiently in this way. This in turn benefits the stabilizing effect of the heat protection element.

The material thickness can also be referred to as the thickness of the heat protection element or wall thickness or something similar. It represents the dimension of the heat protection element perpendicular to its planar extent.

According to a further advantageous embodiment of the invention, the heat protection element is designed as a steel foil, in particular with a material thickness of a maximum of 0.2 millimeters. Steel has a particularly high temperature resistance and a particularly high melting point, so that it can provide particularly good protection and a particularly high stabilizing effect. If the steel foil is designed with a maximum material thickness of 0.2 millimeters, it can still be arranged in a form-fitting and seamless manner on the cell housing, requires hardly any additional installation space and can also be manufactured with a particularly low weight and cost-effectively.

According to a further advantageous embodiment of the invention, the heat protection element is designed as fire protection paper and has a material thickness of a maximum of 0.5 millimeters. Even when the heat protection element is designed as fire protection paper, it can be designed with particularly thin walls and still provide reliable protection.

With such a thin design, the heat protection element can also be initially manufactured as a planar flat element for the production of the cell housing arrangement, e.g. from a flat semi-finished product, and then molded onto the cell housing accordingly. This is particularly advantageous in the case of an angled design of the heat protection element, in particular in the case of a U-shaped design, as described above.

According to a further advantageous embodiment of the invention, the heat protection element is designed to be adhesive to the cell housing, e.g. glued to the cell housing. This makes it particularly easy to fix the heat protection element to the cell housing. In addition, this makes it particularly easy to position the heat protection element seamlessly on the cell housing.

Furthermore, the invention also relates to a battery cell having a cell housing arrangement according to the invention or one of its embodiments.

Furthermore, the invention also relates to a battery for a motor vehicle, which battery has a battery cell according to the invention or one of its embodiments. The battery can have multiple such battery cells, for example. These can be arranged in the form of a cell stack, which can be designed as previously described. The cell stack can also be clamped in the stacking direction. This can increase the stabilizing effect of the fire protection element. The battery can be designed for example as a high-voltage battery.

Moreover, the invention also relates to a motor vehicle having a battery cell according to the invention or one of its embodiments or having a battery according to the invention or one of its embodiments. The motor vehicle according to the invention is preferably designed as an automobile, in particular as a passenger car or truck, or as a passenger bus or motorcycle. A motor vehicle can be, for example, an electric vehicle.

The invention also includes further developments of the battery cell and the battery according to the invention, which have features as already described in connection with the further developments of the cell housing arrangement according to the invention. For this reason, the corresponding developments of the method according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic and perspective representation of a prismatic battery cell with a cell housing arrangement according to an exemplary embodiment of the invention;

FIG. 2 shows a schematic view of the battery cell from FIG. 1 in a side view according to an exemplary embodiment of the invention; and

FIG. 3 shows a schematic cross-sectional representation of the battery cell from FIG. 1 according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

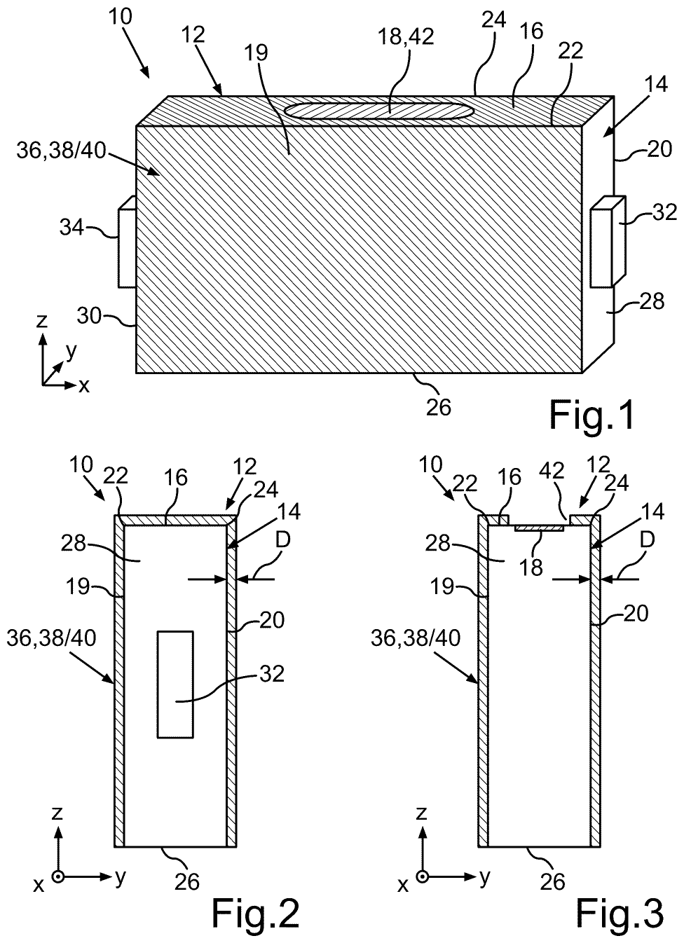

FIG. 1 shows a schematic and perspective representation of a battery cell 10 with a cell housing arrangement 12 according to an exemplary embodiment of the invention. The cell housing arrangement 12 in turn comprises a cell housing 14, which surrounds an interior of the battery cell 10, in which a cell chemical system can be arranged in the battery cell 10. The cell housing 14 comprises a first cell wall 16 in which a releasable cell degassing opening 18, for example a bursting membrane, is arranged. The releasable cell degassing opening 18 can also be referred to as a cell vent or vent or venting opening, for example. In addition, the cell housing 14 comprises a second cell wall 19 and a third cell wall 20, which are opposite each other with respect to the illustrated y-direction. The second cell wall 19 borders on the first cell wall 16 via a first edge 22. The third cell wall 20 borders on the first cell wall 16 via a second edge 24. The edges 22, 24 run in an edge direction which in this case corresponds to the x-direction shown. In addition, the cell housing 14 also comprises a fourth cell wall 26, which is opposite the first cell wall 16 with respect to the illustrated z-direction, as well as a fifth cell wall 28 and a sixth cell wall 30, which are opposite each other with respect to the illustrated x-direction. In the present example, a cell pole 32, 34 is arranged on each of the fifth and sixth cell walls 28, 30.

The cell housing 14 can be made of aluminum, for example. Furthermore, the cell housing arrangement 12 has a heat protection element 36, which is shown hatched in the present case. This can be designed as a metal foil, in particular steel foil 38 or as fire protection paper 40. In this example, the heat protection element 36 is arranged on the outside of the second cell wall 19, the first cell wall 16 and the third cell wall 24 in a flat manner. In the region of the releasable cell degassing opening 18, the heat protection element 36 can be formed with a recess 42. In the present example, the heat protection element 36 extends in the x-direction over the entire first, second and third cell walls 16, 19, 20 and also completely covers the edges 22, 24 in the x-direction.

FIG. 2 shows a schematic side view of the battery cell 10 from FIG. 1 in a plan view on the fifth cell wall 28 and FIG. 3 shows a schematic cross-sectional view of the battery cell 10 from FIG. 1 perpendicular to the illustrated x-direction in the region of the releasable cell degassing opening 18. As can be seen, the heat protection element 36 can be U-shaped. The material thickness D of the heat protection element 36, which can be constant in particular across the heat protection element 36, is in particular less than one millimeter. If the heat protection element 36 is designed as a steel foil 38, the material thickness D is preferably a maximum of 0.2 millimeters and in the case of the design as fire protection paper 40, the material thickness is preferably a maximum of 0.5 millimeters. This allows the heat protection element 36 to be designed to be particularly flexible and conformable. This allows a seamless attachment to the corresponding side walls 19, 16, 20 of the cell housing 14.

If the battery cell 10 is provided, for example, as part of a cell stack with multiple battery cells arranged next to one another in a stacking direction, the stacking direction corresponds to the illustrated y-direction. The heat protection element 36 can thus stabilize, in particular, the side walls 19, 20 facing the neighboring cells and the adjacent edges 22, 24 in the event of outgassing of the battery cell 10 and efficiently prevent undesired outgassing in the direction of neighboring cells.

The heat protection element 36 can, for example, be manufactured as a flat, planar element and then molded to the geometry of the cell housing 14 and thereby be designed in a U-shape. In addition, the heat protection element 36 does not have to extend over the entire cell housing 14 with respect to the x-direction, but can also extend only over a partial region of this cell housing 14, in particular a central region with respect to the x-direction. The heat protection element 36 also does not have to completely cover the side walls 19, 20 in the z-direction, but can also be designed such that it does not extend to the fourth cell wall 26 against the z-direction shown.

Optionally, the cell housing 14 can also be wrapped by the heat protection element 36, so that, for example, at least the fourth cell wall 26 is also partially or completely covered by the heat protection element 36. For example, the cell housing 14 or the battery cell 10 can also be wrapped in the fire protection paper 40.

Overall, the examples show how the invention can provide a stabilization of the cell can, i.e. the cell housing. This can be achieved in particular by applying additional materials to support cell integrity, for example in the form of foils, particularly made of metal, or fire protection materials, such as fire protection paper, especially on the side surfaces of the cell. In the event of degassing of the battery cell, it can open at the cell vent and the rest of the cell housing can remain stable. In particular, the edges of the cell housing that border the cell wall with the cell vent can be reliably protected by the heat protection element. The heat protection element can primarily prevent significant cracks in the cell housing from occurring in the event of a thermal runaway and hot outgassing of the battery cell, as well as the melting of side surfaces or the breaking away of cell edges at the vent interface, which would severely damage the protection of the neighboring cell and thus undesirably promote propagation behavior. By means of the cell housing arrangement according to the invention and its embodiments, a controlled outgassing behavior of the battery cell can be achieved by stabilizing the cells around the vent opening. Stabilization can be achieved by adding additional materials to the cell surfaces in the form of glued-on foils made of metal or paper.

1. A cell housing arrangement, comprising: a cell housing for a prismatic battery cell,
wherein the cell housing has a first cell wall, in which a releasable cell degassing opening is arranged,
has a second and third cell wall which are opposite one another and each adjoin the first cell wall via a first and second edge of the cell housing, and
wherein the cell housing arrangement has at least one heat protection element which is arranged at least externally on at least part of the second cell wall,
wherein the heat protection element is designed as a metal foil or as a fire protection paper.

2. The cell housing arrangement according to claim 1, wherein the heat protection element is arranged on at least a part of the first cell wall and covers at least the first edge at least partially or completely with respect to an edge longitudinal direction.

3. The cell housing arrangement according to claim 1, wherein the heat protection element is also arranged on at least a part of the third cell wall and covers the second edge at least partially or completely with respect to a longitudinal edge direction.

4. The cell housing arrangement according to claim 1, wherein the heat protection element extends on the first cell wall from the first to the second edge and has a recess in the region of the releasable cell degassing opening.

5. The cell housing arrangement according to claim 1, wherein the heat protection element is flexible and in particular has a material thickness of a maximum of one millimeter.

6. The cell housing arrangement according to claim 1, wherein the heat protection element is designed as a steel foil, in particular with a material thickness of a maximum of 0.2 millimeters.

7. The cell housing arrangement according to claim 1, wherein the heat protection element is designed as fire protection paper and has a material thickness of a maximum of 0.5 millimeters.

8. The cell housing arrangement according to claim 1, wherein the heat protection element is glued to the cell housing.

9. A battery cell with a cell housing arrangement according to claim 1.

10. A motor vehicle having a battery cell according to claim 9.

11. The cell housing arrangement according to claim 2, wherein the heat protection element is also arranged on at least a part of the third cell wall and covers the second edge at least partially or completely with respect to a longitudinal edge direction.

12. The cell housing arrangement according to claim 2, wherein the heat protection element extends on the first cell wall from the first to the second edge and has a recess in the region of the releasable cell degassing opening.

13. The cell housing arrangement according to claim 3, wherein the heat protection element extends on the first cell wall from the first to the second edge and has a recess in the region of the releasable cell degassing opening.

14. The cell housing arrangement according to claim 2, wherein the heat protection element is flexible and in particular has a material thickness of a maximum of one millimeter.

15. The cell housing arrangement according to claim 3, wherein the heat protection element is flexible and in particular has a material thickness of a maximum of one millimeter.

16. The cell housing arrangement according to claim 4, wherein the heat protection element is flexible and in particular has a material thickness of a maximum of one millimeter.

17. The cell housing arrangement according to claim 2, wherein the heat protection element is designed as a steel foil, in particular with a material thickness of a maximum of 0.2 millimeters.

18. The cell housing arrangement according to claim 3, wherein the heat protection element is designed as a steel foil, in particular with a material thickness of a maximum of 0.2 millimeters.

19. The cell housing arrangement according to claim 4, wherein the heat protection element is designed as a steel foil, in particular with a material thickness of a maximum of 0.2 millimeters.

20. The cell housing arrangement according to claim 5, wherein the heat protection element is designed as a steel foil, in particular with a material thickness of a maximum of 0.2 millimeters.
